(19) United States
(12) Patent Application Publication
(10) Pub. No.: US 2018/0357707 A1
(43) Pub. Date: Dec. 13, 2018

(54) METHOD FOR ONE-CLICK PURCHASING AND APPARATUS THEREFOR

(71) Applicant: SK Planet Co., Ltd., Seongnam-si (KR)

(72) Inventor: Dong-Hee LEE, Seoul (KR)

(73) Assignee: SK Planet

(21) Appl. No.: 15/984,011

(22) Filed: May 18, 2018

(30) Foreign Application Priority Data
Jun. 12, 2017 (KR) 10-2017-0073040

(51) Int. Cl. G06Q 30/06

(52) U.S. Cl. CPC G06Q 30/0633; G06Q 30/0641

(57) ABSTRACT

Disclosed herein are a method and apparatus for one-click purchasing. The repeated order pattern of a user is analyzed based on the purchase information of the user stored through an application, an automatically repeating order for the user is generated based on the repeated order pattern, an event time corresponding to the automatically repeating order is set, and information about an event corresponding to the automatically repeating order may be sent to the user using a one-click push message at the event time. An event for appropriately placing an order depending on the user's situation may be generated, whereby a user may automatically place an order depending on the circumstances without manually making complicated settings.

### CROSS REFERENCE TO RELATED APPLICATION

This application claims the benefit of Korean Patent Application No. 10-2017-0073040, filed Jun. 12, 2017, which is hereby incorporated by reference in its entirety into this application.

### BACKGROUND OF THE INVENTION

### 1. Technical Field

The present invention relates generally to a one-click purchasing technique, and more particularly to a one-click purchasing method and apparatus, through which users may easily order repeatedly purchased products at an appropriate time.

### 2. Description of the Related Art

A one-click purchasing technique is configured such that a customer stores data about a delivery address and personal information online in advance so that the customer may easily buy products using the corresponding data when necessary. That is, the one-click purchasing technique is literally a technique for helping a customer purchase a selected item with only a single click without the need to again input or reconfirm customer information. The use of this technique may simplify not only an ordering process but also a purchasing process when customers buy products or items on the Internet, because there is no need to input personal payment information, such as a credit card number or the like, every time a purchase is made. In connection with this, Korean Patent Application Publication No. 10-2006-0023202 (published on Mar. 14, 2006) discloses a technology related to “Business method and system for promoting PPL effect and product sales using mobile device.”

### SUMMARY OF THE INVENTION

An object of the present invention is to provide a method for enabling a user to easily order a menu item that is frequently used by the user before the user arrives at a store.

Another object of the present invention is to automatically search for a product suitable for a user and provide information thereabout, whereby the user may select and order a better product and a seller may increase sales.

A further object of the present invention is to generate an event for enabling a user to place an order appropriate for his or her situation, whereby the user may automatically place an order depending on the circumstances without manually making complicated settings.

In order to accomplish the above objects, a method for one-click purchasing according to the present invention includes analyzing a repeated order pattern of a user based on purchase information of the user, which is stored through an application; generating an automatically repeating order for the user based on the repeated order pattern; and setting an event time for the automatically repeating order and sending information about an event corresponding to the automatically repeating order to the user at the event time using a one-click push message.

Here, the method may further include checking whether an event having a comparative advantage over the automatically repeating order is generated; and providing information for a more advantageous purchase along with the one-click push message when the event having the comparative advantage is generated.

Here, sending the information about the event may be configured to decide whether to send the information about the event depending on whether the user moves along a routine route extracted from the repeated order pattern when a current time is the event time.

Here, sending the information about the event may include setting the event time based on at least one of a repeated order time of the user, extracted from the repeated order pattern, and a time taken for a store taking the automatically repeating order to prepare an ordered product.

Here, setting the event time may include calculating an expected arrival time of the user based on a current position of the user and changing the event time in consideration of the expected arrival time.

Here, the method may further include determining whether there is information for the more advantageous purchase by comparing a store corresponding to the automatically repeating order with multiple stores registered in the application based on order information corresponding to the automatically repeating order, and then generating the event having a comparative advantage when it is determined that there is the information for the more advantageous purchase.

Here, generating the event having a comparative advantage may be configured to compare the store with the multiple stores based on at least one of a price of a menu item, a location of the store, coupon information, and a grade.

Here, the method may further include placing the automatically repeating order with a store corresponding to the automatically repeating order when the user requests the automatically repeating order based on the event.

Also, a server according to the present invention includes an operation unit for analyzing a repeated order pattern of a user based on purchase information of the user, which is stored through an application; a generation unit for generating an automatically repeating order for the user based on the repeated order pattern; and a control unit for setting an event time for the automatically repeating order and sending the user information about an event corresponding to the automatically repeating order using a one-click push message at the event time.

Here, the server may further include a monitoring unit for checking whether an event having a comparative advantage over the automatically repeating order is generated, and the control unit may provide information for a more advantageous purchase along with the one-click push message when the event having a comparative advantage is generated.

Here, the control unit may decide whether to send the information about the event depending on whether the user moves along a routine route extracted from the repeated order pattern when a current time is the event time.

Here, the control unit may set the event time based on at least one of a repeated order time of the user, extracted from the repeated order pattern, and a time taken for a store taking the automatically repeating order to prepare an ordered product.

Here, the control unit may calculate an expected arrival time of the user based on a current position of the user, and may change the event time in consideration of the expected arrival time.

Here, the monitoring unit may determine whether there is information for the more advantageous purchase by comparing a store corresponding to the automatically repeating order with multiple stores registered in the application based on order information corresponding to the automatically repeating order, and may generate the event having a comparative advantage when it is determined that there is the information for the more advantageous purchase.

Here, the control unit may compare the store with the multiple stores based on at least one of a price of a menu item, a location of the store, coupon information, and a grade.

Here, the control unit may place the automatically repeating order with a store corresponding to the automatically repeating order when the user requests the automatically repeating order based on the event.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a system for one-click purchasing according to an embodiment of the present invention;

FIG. 2 is a flowchart that shows a method for one-click purchasing according to an embodiment of the present invention;

FIG. 3 is a flowchart that shows an example of the process of providing information for a more advantageous purchase in a one-click purchasing method according to the present invention;

FIG. 4 is a flowchart that shows an example of the process of sending information about an event to a user in a one-click purchasing method according to the present invention;

FIG. 5 is a flowchart that shows an example of the process of changing an event time in a one-click purchasing method according to the present invention;

FIG. 6 and FIG. 7 are views that show an example of a one-click push message provided to a user according to the present invention;

FIG. 8 is a view for explaining the process of setting an event time based on the expected arrival time of a user according to the present invention; and

FIG. 9 is a block diagram that shows a server for one-click purchasing according to an embodiment of the present invention.

### DESCRIPTION OF THE PREFERRED EMBODIMENTS

Technical terms used in this specification are used to describe only specific embodiments, and it is to be noted that these terms are not intended to limit the present invention. Also, the technical terms used in this specification should be interpreted as having meanings that are commonly understood by a person having ordinary skill in the art to which the present invention pertains, unless specifically defined in this specification, and should not be interpreted as having excessively comprehensive meanings or excessively reduced meanings. Furthermore, if the technical terms used in this specification are misleading technical terms that do not precisely represent the spirit of the present invention, they should be replaced with technical terms that may be correctly understood by a person having ordinary skill in the art. Also, common terms used in the present invention should be interpreted in accordance with dictionary definitions or in accordance with the context, and should not be interpreted as having excessively narrow meanings.

An expression of the singular number used in this specification includes an expression of the plural number unless clearly defined otherwise in the context. In this application, terms such as “comprise” and “include” should not be interpreted as necessarily including all of several elements or several steps described in the specification, but should be interpreted as possibly excluding some of the elements or steps or as possibly including additional elements or steps.

Terms including ordinal numbers, such as “first”, “second”, and the like, used in this specification, may be used to describe a variety of elements, but the elements should not be construed as being limited by the terms. The terms are used to only distinguish one element from another element. For example, a first element may be named a second element and likewise a second element may be named a first element without departing from the scope of the present invention.

Hereinafter, preferred embodiments in accordance with the present invention are described in detail with reference to the accompanying drawings. The same or similar elements are assigned the same reference numerals irrespective of reference numerals, and a redundant description thereof is omitted.

In the following description of the present invention, detailed descriptions of known functions and configurations that are deemed to make the gist of the present invention obscure will be omitted. The accompanying drawings of the present invention aim to facilitate understanding of the present invention, and the spirit of the present invention should not be construed as being limited to the accompanying drawings.

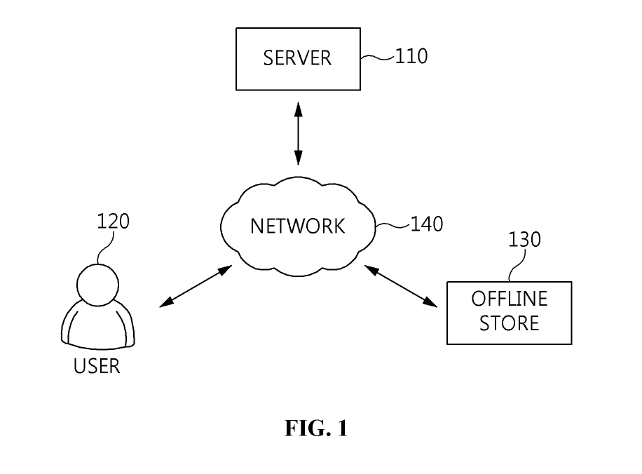

FIG. 1 is a view that shows a system for one-click purchasing according to an embodiment of the present invention.

Referring to FIG. 1, a system for one-click purchasing according to an embodiment of the present invention includes a server 110, a user 120, an offline store 130, and a network 140.

The server 110 according to an embodiment of the present invention may be a device for sending and receiving data for one-click purchasing by communicating with the user 120 or the offline store 130 over the network 140. That is, the server 110 may function to provide information to a user terminal carried by the user 120 and to send the offline store 130 an order corresponding to input received from the user terminal.

To this end, the server 110 first analyzes a repeated order pattern of the user 120 based on purchase information of the user 120, which is stored through an application.

Here, the purchase information may be collected using the application and stored in a database for respective users.

Also, the server 110 generates an automatically repeating order for the user based on the repeated order pattern.

Here, the automatically repeating order may be order information for buying a product corresponding to the repeated order pattern at a time corresponding to the repeated order pattern.

Also, the server 110 sets an event time for the automatically repeating order, and sends the user 120 information about an event corresponding to the automatically repeating order using a one-click push message at the event time.

Here, when the current time is the event time, whether to send information about the event may be determined depending on whether the user 120 is moving along a routine route extracted from the repeated order pattern.

Here, the event time may be set based on at least one of the repeat order time of the user 120, which is extracted from the repeated order pattern, and the time taken for the store 130, which takes the automatically repeating order, to prepare an ordered product.

Here, the expected arrival time of the user 120 is calculated based on the current position of the user 120, and the event time may be changed in consideration of the expected arrival time.

Also, the server 110 checks whether an event having a comparative advantage over the automatically repeating order is generated, and provides information for a more advantageous purchase along with a one-click push message when the event having a comparative advantage is generated.

Also, based on order information corresponding to the automatically repeating order, the server 110 determines whether information for a more advantageous purchase is present by comparing the store 130 corresponding to the automatically repeating order with multiple stores registered in the application, and generates an event having a comparative advantage when information for a more advantageous purchase is present.

Here, based on at least one of the price of menu items, the location of a store, coupon information, and a grade, the store 130 corresponding to the automatically repeating order may be compared with multiple stores.

Also, when the user 120 requests an automatically repeating order based on the event, the server 110 places an automatically repeating order with the corresponding offline store 130.

That is, an order is actually placed with the offline store 130 based on the order information corresponding to the automatically repeating order, whereby the user may receive the ordered product when he or she visits the offline store 130.

Here, the user 120 illustrated in FIG. 1 may be a person who carries a user terminal in which an application is installed, or may be the user terminal itself.

That is, the user terminal may be a terminal device in which one-click purchasing is made based on a one-click push message according to an embodiment of the present invention.

For example, the user terminal is a device on which an application according to the present invention may run by being connected with a communication network, and may be any of various types of terminals including all types of information communication terminals, multimedia terminals, Internal Protocol (IP) terminals, and the like, rather than being limited to mobile communication terminals. Also, the user terminal may be a mobile terminal having various mobile communication specifications, such as a mobile phone, a Portable Multimedia Player (PMP), a Mobile Internet Device (MID), a smartphone, a tablet PC, a laptop, a netbook, a Personal Digital Assistant (PDA), an information communication device, and the like.

Also, the user terminal may receive various kinds of information, such as numbers, letters, and the like, and may deliver signals, input for setting various functions and controlling the functions of the user terminal, to the control unit via the input unit. Also, the input unit of the user terminal may be configured so as to include at least one of a keypad and a touch pad, which generate an input signal in response to the touch or manipulation by a user. Here, the input unit of the user terminal and the display unit thereof may form a single touch panel (or a touch screen), thereby performing both an input function and a display function. Also, the input unit of the user terminal may use all types of input means that may be developed in the future as well as currently existing input devices such as a keyboard, a keypad, a mouse, a joystick, and the like. Particularly, the input unit of the user terminal according to the present invention may deliver a one-touch input signal for one-click ordering to the control unit of the user terminal.

Also, the display unit of the user terminal may display information about a series of operation states and operation results generated while the function of the user terminal is being performed. Also, the display unit of the user terminal may display the menu of the user terminal and user data input by a user. Here, the display unit of the user terminal may be configured with a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the user terminal is configured in the form of a touch screen, the display unit of the user terminal may perform some or all of the functions of the input unit of the user terminal. Particularly, the display unit of the user terminal according to the present invention may display an interface provided for one-click ordering and information about execution of the application on a screen.

Also, the storage unit of the user terminal may include a main storage device and an auxiliary storage device as devices for storing data, and may store applications that are necessary for the operation of the user terminal. The storage unit of the user terminal may include a program area and a data area. Here, when the user terminal activates each function in response to a request from a user, the user terminal provides the function by running corresponding applications under the control of the control unit. Particularly, the storage unit of the user terminal according to the present invention may store an Operating System (OS) for booting the user terminal, an application for sending and receiving information input for one-click ordering, and the like. Also, the storage unit of the user terminal may store information about the user terminal and a content DB for storing multiple pieces of content. Here, the content DB may include execution data for executing content and attribute information about the content, and may store content usage information in response to the execution of the content. Also, the information about the user terminal may include specifications of the user terminal.

Also, the communication unit of the user terminal may function to send and receive data to and from the server 110 over the network 140. Here, the communication unit of the user terminal may include an RF transmission medium for up-conversion and amplification of the frequency of a sending signal and an RF reception medium for low-noise amplification of a receiving signal and down-conversion of the frequency thereof. Such a communication unit of the user terminal may include a wireless communication module. Also, the wireless communication module is a component for sending or receiving data based on a wireless communication method, and may send and receive data to and from the server 110 using any one of a wireless network communication module, a wireless LAN communication module, and a wireless PAN communication module when the user terminal uses wireless communication. That is, the user terminal may access the network 140 using a wireless communication module, and may send and receive data to and from the server 110 over the network 140. Particularly, the network 140 according to the present invention may send and receive data that are necessary for one-click purchasing by communicating with the server 110 or the user terminal.

Also, the control unit of the user terminal may be a processing device for running an Operating System (OS) and each component. For example, the control unit may control the overall process of accessing the server 110. When access to the server 110 is made through an application, the control unit may control the overall process of running the application in response to the request by a user, and may perform control so as to send a request for using a service to the server 110 simultaneously with execution of the application. Here, the control unit may perform control such that information about the user terminal required for user authentication is sent along with the request.

The offline store 130 corresponds to an actual store for taking an order for a menu item or product through one-click purchasing according to an embodiment of the present invention, and may be a store that is often used by the user 120.

The network 140 may provide a channel via which the server 110, the user terminal of the user 120, and the offline store 130 may deliver data therebetween, and may be conceptually understood as including networks that are currently being used and networks that have yet to be developed. For example, the network may be any one of wired and wireless local networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future.

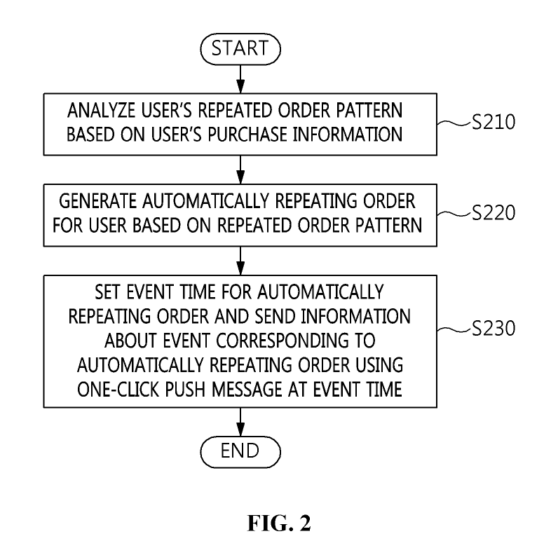

FIG. 2 is a flowchart that shows a method for one-click purchasing according to an embodiment of the present invention.

Referring to FIG. 2, in the method for one-click purchasing according to an embodiment of the present invention, a repeated order pattern of a user is analyzed at step S210 based on the purchase information of the user, which is stored through an application.

Here, the application may run based on a server for one-click purchasing, and may be a program used for paying for an item or product purchased by a user. For example, because the payment method of a user is registered in the application, purchase information may be generated whenever the user buys a product using the corresponding payment method.

Here, the purchase information may be stored so as to match the account of each user in the application, and may alternatively be stored in a separate database for one-click purchasing.

Here, the database may be included in the server for one-click purchasing, or may be separate therefrom.

Here, the repeated order pattern may be detected based on similar purchases that are repeatedly found in the user's purchase list included in the purchase information. For example, if user A orders an Americano at café B at 8:30 a.m. on weekdays, information, such as “8:30 a.m. on weekdays, café B, Americano”, in which the time and the place at which an order is placed and an ordered item are sequentially listed, may be extracted as the repeated order pattern of user A.

Here, the repeated order pattern may be extracted based on purchases repeatedly found more than a preset number of times in the purchase information of the user.

For example, if the preset number is five, when user A orders chicken from chicken restaurant C on the first Sunday for five successive months, information such as “the first Sunday of every month, chicken restaurant C, chicken” may be extracted as the repeated order pattern of user A.

Here, because a repeated order pattern is analyzed and extracted depending on the preset number, a single user may have multiple repeated order patterns.

In the above examples, the first repeated order pattern, corresponding to “8:30 a.m. on weekdays, café B, Americano”, and the second repeated order pattern, corresponding to “the first Sunday of every month, chicken restaurant C, chicken”, may be analyzed and extracted for user A.

Also, in the method for one-click purchasing according to an embodiment of the present invention, an automatically repeating order for the user is generated at step S220 based on the repeated order pattern.

Here, the automatically repeating order may be data for automatically and repeatedly placing an order corresponding to the repeated order pattern.

For example, when the repeated order pattern of user A is “8:30 a.m. on weekdays, café B, Americano”, an automatically repeating order may be generated in order to actually order an Americano from café B at 8:30 a.m. on weekdays.

Here, the automatically repeating order may be generated in the server so as to be placed through the application. For example, the repeated order pattern of user A is analyzed and extracted, and order data corresponding to the automatically repeating order may be connected with user A's information registered in the application. That is, through the user account in the application, order data for the automatically repeating order for each user may be managed.

Also, in the method for one-click purchasing according to an embodiment of the present invention, an event time for the automatically repeating order is set, and information about an event corresponding to the automatically repeating order is sent to the user at the event time using a one-click push message at step S230.

Here, the event time may be the time at which the one-click push message is to be sent in order to provide the user with the event corresponding to the automatically repeating order.

Here, the one-click push message may be displayed on the display of the user terminal of the user.

Here, the one-click push message may include a question asking the user whether to use the automatically repeating order. That is, the one-click push message may provide a user interface through which the user may decide whether to use the automatically repeating order with a single click or a single touch.

For example, the one-click push message may include an order button for ordering a menu item or a product using the automatically repeating order and a cancel button for canceling the automatically repeating order.

Here, when the current time is the event time, whether to send information about the event may be determined depending on whether the user is moving along a routine route extracted from the repeated order pattern.

For example, assume that an automatically repeating order for ordering a ham and cheese sandwich from sandwich shop B at 8 a.m. on weekdays is generated for user A, and that a routine route is a route along which user A goes to work from home. Here, if user A moves to another place at 8 a.m. on a weekday for a business trip, the provision of information about the event corresponding to the automatically repeating order may become a useless operation that needlessly loads the server.

Accordingly, in order to prevent this problem, whether the route along which a user is moving matches a routine route extracted from the repeated order pattern is checked first, and then the one-click push message may be sent to the user terminal of the user.

For example, the route along which the user is moving may be tracked or acquired using a GPS included in the user terminal. Here, without limitation to the method using the GPS, various methods and methods that have yet to be developed may be used to track or acquire the route along which the user is moving.

Here, the event time may be set based on at least one of the repeated order time of the user, extracted from the repeated order pattern, and the time taken for the store taking the automatically repeating order to prepare the ordered item.

For example, if the repeated order pattern of user B is “9 a.m. on weekdays, the café in front of the house, Café Latte”, the event time at which a one-click push message is to be sent may be set to be earlier than 9 a.m. That is, because it is expected that user B arrives at the café in front of the house at 9 a.m. based on the repeated order time, the event time may be set such that preparation of a Café Latte is completed when user B arrives. If it takes about 5 minutes to make a Café Latte, the event time is set to 8:55 a.m., so that the one-click push message may be sent at 8:55 a.m. on weekdays.

Therefore, according to an embodiment of the present invention, the event time may be set differently depending on the type of product that is repeatedly ordered using the automatically repeating order.

Here, the expected arrival time of the user is calculated based on the current position of the user, and the event time may be changed in consideration of the expected arrival time. That is, although a user repeatedly buys a certain product in the offline store, the user may not always visit the offline store at the same time. Therefore, for the store expected to be visited by the user using the repeated order pattern, the expected arrival time of the user is calculated, and the event time may be adjusted depending on the expected arrival time.

In the above example, when user B arrives at the café at 9:30 a.m., which is 30 minutes later than usual, a Café Latte made in response to a one-click message sent at 8:55 a.m. would get cold because user B arrives 30 minutes after the Café Latte is made. That is, because it is difficult for user B to always arrive at the café at precisely 9 a.m., the event time may be changed such that the Café Latte is made by the time at which the user is expected to arrive at the café.

Also, although not illustrated in FIG. 2, in the method for one-click purchasing according to an embodiment of the present invention, whether an event having a comparative advantage over the automatically repeating order is generated is checked, and information for a more advantageous purchase is provided to the user along with the one-click push message when the event having a comparative advantage is generated.

Here, the event having a comparative advantage may be an event that is generated in order to provide information for a more advantageous purchase when there is information that is more advantageous or efficient to a user than the purchase using the automatically repeating order.

Also, although not illustrated in FIG. 2, in the method for one-click purchasing according to an embodiment of the present invention, whether information for a more advantageous purchase is present is determined by comparing a store corresponding to the automatically repeating order with multiple stores registered in the application based on order information corresponding to the automatically repeating order, and an event having a comparative advantage is generated when the information for a more advantageous purchase is present.

Here, based on at least one of the price of menu items, the location of a store, coupon information, and a grade, the store corresponding to the automatically repeating order may be compared with multiple stores.

For example, assume that there is a user who repeatedly buys chicken at store A in the evening of the first Sunday of every month using a one-click push message. Here, if store B, located near store A, sells chicken at a lower price than store A, among the multiple stores registered in the application, it is determined that there is information for a more advantageous purchase, which corresponds to store B, and an event having a comparative advantage may be generated.

Alternatively, in the above example, if store A and store B sell chicken at the same price but store B is offering a coupon through which chicken is provided free when chicken is bought ten times at store B, it may be determined that there is information for a more advantageous purchase.

Alternatively, in the above example, when store A and store B sell chicken at the same price and offer a coupon under the same conditions, but store B is more accessible than store A based on the position of the user, it may be determined that there is information for a more advantageous purchase.

Alternatively, in the above example, when store A and store B sell chicken at the same price, offer a coupon under the same conditions, and have the same accessibility, but the grade of store B given by users is higher than the grade of store A, it may be determined that there is information for a more advantageous purchase.

Also, although not illustrated in FIG. 2, in the method for one-click purchasing according to an embodiment of the present invention, when a user requests an automatically repeating order based on the event, the automatically repeating order is placed with the store corresponding to the automatically repeating order.

Here, the server according to an embodiment of the present invention sends an order corresponding to the automatically repeating order to the store, whereby the store may prepare a menu item or product corresponding to the automatically repeating order.

Here, the payment for the automatically repeating order may be made using the payment method of the user registered in the application. For example, a user may register his or her credit card information in the application, or may load money onto online cash, corresponding to the payment method in the application, and use the online cash for the automatically repeating order.

Here, the store taking the order may deliver the ordered menu item or product to the user after checking the user based on the user information corresponding to the automatically repeating order.

In FIG. 2, a store, such as a café or a restaurant, is described by way of example, but the method for one-click purchasing according to the present invention may be applied to any store from which a product may be purchased using the user terminal based on the one-click push message, rather than being limited to stores in a specific category.

Through the method for one-click purchasing, a user may easily order a menu item that is frequently used by the user before arriving at the store.

Also, a product that is suitable for a user is automatically found and information thereabout is provided, whereby the user may select and order a better product, and a seller may increase his or her sales.

Also, an event for placing an order appropriate for a user's situation is generated, whereby the user may automatically place an order depending on the circumstances without manually making complicated settings.

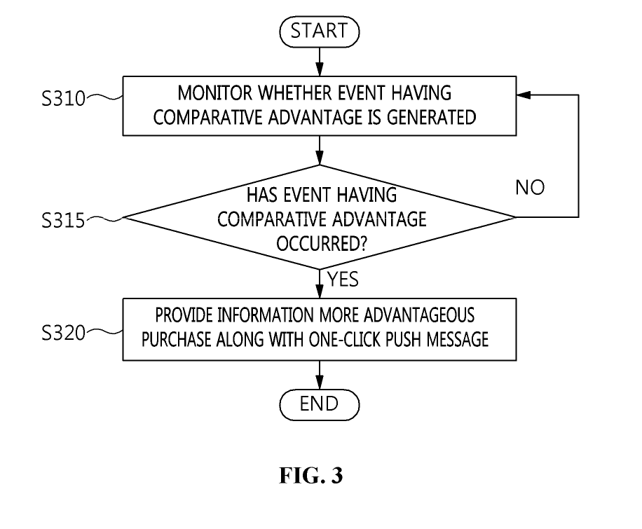

FIG. 3 is a flowchart that shows an example of the process of providing information for a more advantageous purchase in the method for one-click purchasing according to the present invention.

Referring to FIG. 3, in the process of providing information for a more advantageous purchase, first, whether an event having a comparative advantage is generated may be monitored at step S310.

Here, the event having a comparative advantage may be an event that is generated in order to provide information for a more advantageous purchase when there is information that is more advantageous or efficient to a user than a purchase made using the automatically repeating order.

For example, among multiple stores registered in the application, information about a store associated with the automatically repeating order of a user is analyzed, whereby whether an event having a comparative advantage over the automatically repeating order is generated may be monitored. That is, information about the store associated with the automatically repeating order of the user is analyzed, whereby whether there is information about a more advantageous purchase than a menu item or product corresponding to the automatically repeating order may be monitored.

Here, based on at least one of the price of menu items, the location of a store, coupon information, and a grade, the store corresponding to the automatically repeating order may be compared with the multiple stores.

For example, assume that there is a user who repeatedly buys chicken at store A in the evening of the first Sunday of every month using a one-click push message. Here, if store B, located near store A, sells chicken at a lower price than store A, among the multiple stores registered in the application, it is determined that there is information for a more advantageous purchase, which corresponds to store B, and an event having a comparative advantage may be generated.

Alternatively, in the above example, if store A and store B sell chicken at the same price but store B is offering a coupon through which chicken is provided free when chicken is bought ten times at store B, it may be determined that there is information for a more advantageous purchase.

Alternatively, in the above example, when store A and store B sell chicken at the same price and offer a coupon under the same conditions, but store B is more accessible than store A based on the position of the user, it may be determined that there is information for a more advantageous purchase.

Alternatively, in the above example, when store A and store B sell chicken at the same price, offer a coupon under the same conditions, and have the same accessibility, but the grade of store B given by users is higher than the grade of store A, it may be determined that there is information for a more advantageous purchase.

Then, whether an event having a comparative advantage is generated is determined at step S315, and when it is determined at step S315 that such an event is generated, information for a more advantageous purchase may be provided to the user along with the one-click push message at step S320.

For example, when the one-click push message is output via the display of the user terminal, an icon indicating the presence of information for a more advantageous purchase may be provided therewith. Also, when the user selects the icon, the details of the information may be provided for comparison with the details of the existing automatically repeating order.

Here, an order button for placing an order corresponding to the information for the more advantageous purchase is also provided, whereby the user may automatically place an order corresponding to the information for the more advantageous purchase with only a single click.

Also, when it is determined at step S315 that no event having a comparative advantage is generated, monitoring may be continually performed.

Here, monitoring may be performed in consideration of the position of a user or the location of an offline store corresponding to the automatically repeating order. For example, monitoring may be performed by analyzing information about a store located within a certain range based on at least one of the position of a user and the location of an offline store corresponding to the automatically repeating order, among multiple stores registered in the application.

Here, the monitoring method is not limited to a specific method.

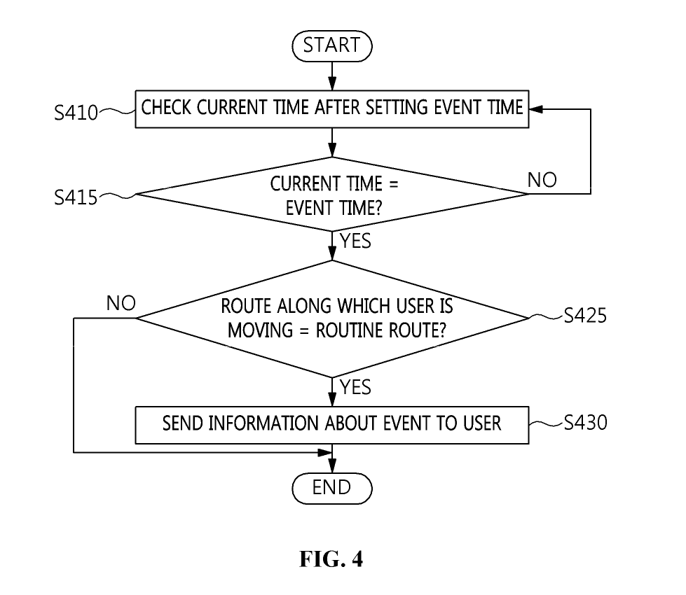

FIG. 4 is a flowchart that shows an example of the process of sending information about an event to a user in the method for one-click purchasing according to the present invention.

Referring to FIG. 4, in the process of sending information about an event to a user, the current time may be checked at step S410 after an event time is set.

Here, the event time may be the time at which a one-click push message is to be sent in order to provide a user with information about an event corresponding to an automatically repeating order according to the present invention.

Here, the event time may be set in consideration of the repeated order time of the user, extracted from the repeated order pattern, or the time taken for a store taking the automatically repeating order to prepare the ordered product.

For example, if the repeated order pattern of user B is “9 a.m. on weekdays, the café in front of the house, Café Latte”, the event time at which a one-click push message is to be sent may be set to be earlier than 9 a.m. That is, because it is expected that user B arrives at the café in front of the house at 9 a.m. based on the repeated order time, the event time may be set such that preparation of a Café Latte is completed when user B arrives. If it takes about 5 minutes to make a Café Latte, the event time is set to 8:55 a.m., so that the one-click push message may be sent at 8:55 a.m. on weekdays.

Then, whether the current time is the event time is determined at step S415, and when it is determined at step S415 that the current time is not the event time, the current time may be continually checked at step S410.

Also, when it is determined at step S415 that the current time is the event time, whether the route along which a user is moving is the same as a routine route extracted from the repeated order pattern may be determined at step S425.

That is, even if the current time is the event time, when the user is moving along a route that is different from the route corresponding to the repeated order pattern because of an unusual schedule, the one-click push message sent to the user may be useless.

For example, assume that an automatically repeating order for ordering a ham and cheese sandwich from sandwich shop B at 8 a.m. on weekdays is generated for user A, and that a routine route is a route along which user A goes to work from home. Here, if user A moves to another place at 8 a.m. on a weekday for a business trip, the provision of information about the event corresponding to the automatically repeating order may become a useless operation that needlessly loads the server.

Accordingly, before a one-click push-message is sent because the current time is the event time, the process of checking whether the route along which a user is moving matches a routine route extracted from the repeated order pattern may be performed.

When it is determined at step S425 that the route along which the user is moving is the routine route, information about the event may be provided at step S430 by sending a one-click push message to the user.

Also, when it is determined at step S425 that the route along which the user is moving does not match the routine route, the event may be terminated without sending the one-click push message to the user.

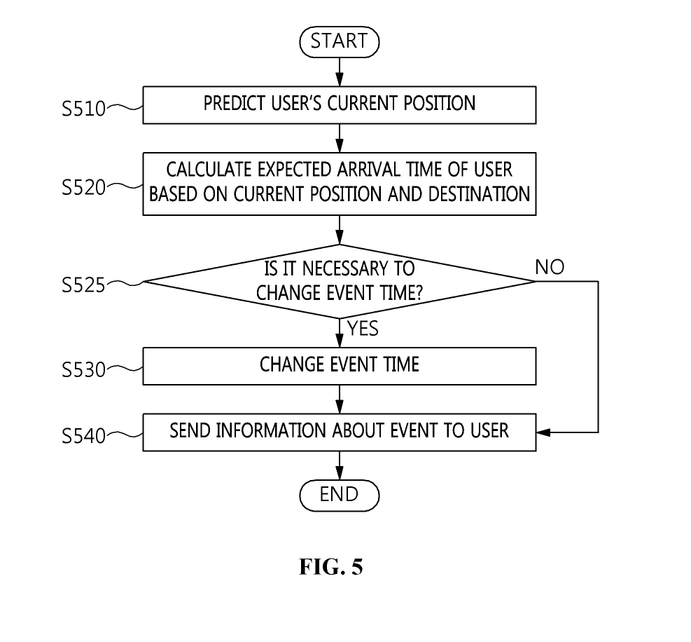

FIG. 5 is a flowchart that shows an example of the process of changing an event time in the method for one-click purchasing according to the present invention.

Referring to FIG. 5, in the process of changing an event time, the current position of a user may be predicted at step S510.

For example, the position of the user may be predicted using a GPS included in the user terminal. Here, the method of predicting the position of the user is not limited to a specific method, and the position of the user may be predicted based on any of various available methods.

Then, the expected arrival time of the user may be calculated at step S520 based on the current position of the user and the destination corresponding to the automatically repeating order.

That is, the time at which the user is expected to arrive at the offline store corresponding to the automatically repeating order may be calculated based on the current position of the user.

Then, whether it is necessary to change the event time of the user may be determined at step S525 based on the expected arrival time.

For example, when the event time is set to 8:30 a.m. but the expected arrival time of the user is 8:20 a.m., the user may arrive at the offline store and order a menu item before the user receives a one-click push message. Accordingly, it may be determined that it is necessary to advance the event time.

For example, assume that the event time is 8:30 a.m., that the expected arrival time of the user is 9 a.m., and that the product corresponding to the automatically repeating order is a hot Café Latte. Here, the Café Latte made in response to an order placed at 8:30 using a one-click push message may become cold before being given to the user due to waiting for the user until 9 a.m. Accordingly, it may be determined that it is necessary to delay the event time.

When it is determined at step S525 that it is necessary to change the event time, the event time is changed by advancing or delaying the event time at step S530, and the event may be provided to the user at the time corresponding to the changed event time at step S540.

Also, when it is determined at step S525 that it is unnecessary to change the event time, the event may be provided to the user at the already determined event time at step S540.

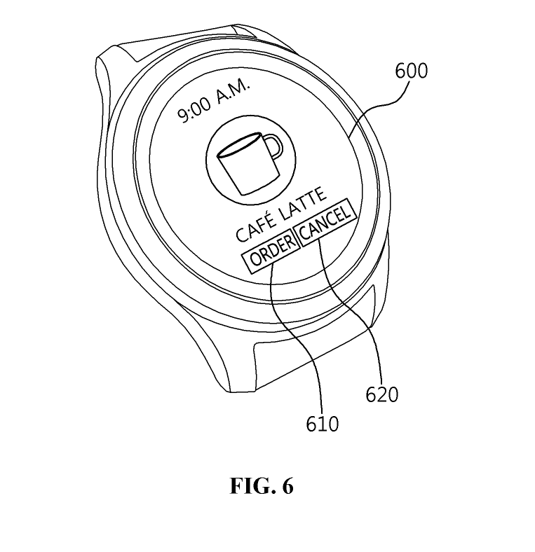

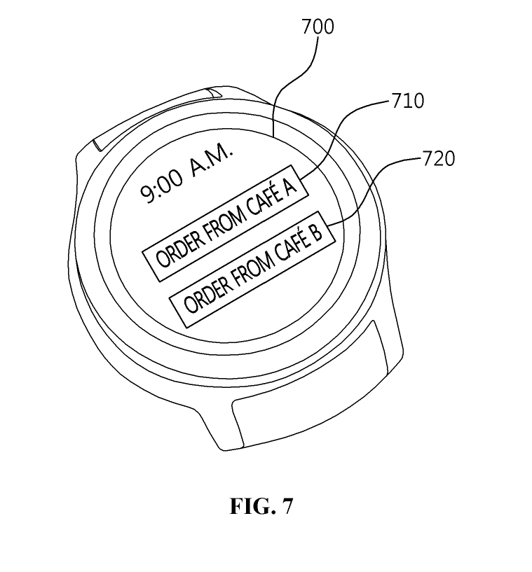

FIG. 6 and FIG. 7 are views that show an example of a one-click push message provided to a user according to the present invention.

FIG. 6 and FIG. 7 show that a one-click push message according to the present invention is provided through the smartwatch 600 or 700 of a user.

Here, the smartwatch 600 or 700 may correspond to a user terminal according to an embodiment of the present invention, and may output a one-click push message on a display based on an application for one-click purchasing.

Here, the one-click push message according to an embodiment of the present invention may output information about a product to be ordered using an automatically repeating order, as shown in FIG. 6.

Also, the one-click push message provides a user with an order button 610 and a cancel button 620 for deciding whether to use the automatically repeating order, whereby the user may decide whether to order a Café Latte with a single click or a single touch.

Also, the one-click push message according to an embodiment of the present invention may output information about the store taking the automatically repeating order, as shown in FIG. 7.

For example, when a user touches a selective order button 710 for ordering from café A, among selective order buttons 710 and 720, an automatically repeating order corresponding to café A may be placed.

Also, although not illustrated in FIG. 6 and FIG. 7, the one-click push message according to an embodiment of the present invention may provide information for a more advantageous purchase along with information about the menu item of the automatically repeating order and information about the store corresponding to the automatically repeating order, respectively illustrated in FIG. 6 and FIG. 7, when there is an event having a comparative advantage over the automatically repeating order.

For example, a notification icon for indicating that there is information for a more advantageous purchase may be generated and displayed on one side of the display of the smartwatch illustrated in FIG. 6. Here, when a user touches the icon, the details of the information may be provided, and an order button for one-click payment for the more advantageous purchase may also be provided.

As described above, the one-click push message according to an embodiment of the present invention may be provided in various forms without being limited to the form illustrated in FIG. 6 or FIG. 7.

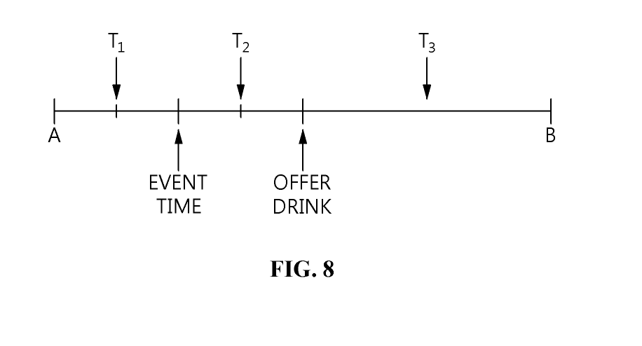

FIG. 8 is a view for explaining the process of setting an event time based on the expected arrival time of a user according to the present invention.

Referring to FIG. 8, the event time according to an embodiment of the present invention may change depending on the expected arrival time T₁, T2, and T3 of a user.

For example, it may be assumed that it takes a certain time period from the event time for the automatically repeating order to the time at which a drink ordered at the event time is offered, as shown in FIG. 8.

Here, if the time at which a user is expected to arrive at the café from which a drink is to be provided is T2, the user may be given a drink that has been made shortly before he or she arrives at the café. That is, when the expected arrival time of the user is considered, it may be determined that the automatically repeating order is placed at an appropriate time.

However, if the time at which a user is expected to arrive at the café from which a drink is to be provided is T₁, the user arrives at the café and orders the drink before receiving a one-click push message. That is, when the expected arrival time of the user is considered, it may be determined that the automatically repeating order is too late. In this case, the event time may be advanced in the direction of A so as to be earlier than T₁.

Here, if the time at which a user is expected to arrive at the café from which a drink is to be provided is T3, the user may arrive at the café a long time after the drink is made in response to the automatically repeating order. Here, if the drink is a cold drink with ice or a hot drink, the ice may melt or the hot drink may get cold, so the taste thereof may change. That is, when the expected arrival time of the user is considered, it may be determined that the automatically repeating order is too early. In this case, the event time may be delayed in the direction of B such that the time at which the drink is provided is later than T3.

Here, although an example in which the product to be ordered in response to the automatically repeating order is a drink has been described in FIG. 8, the product to be ordered in response to the automatically repeating order according to the present invention may be any of various items, and is not limited to a drink. Also, because the period from the event time to the time at which a product is to be offered may vary depending on the type of product corresponding to the automatically repeating order, the event time may be changed in consideration of the period when it is necessary to change the event time.

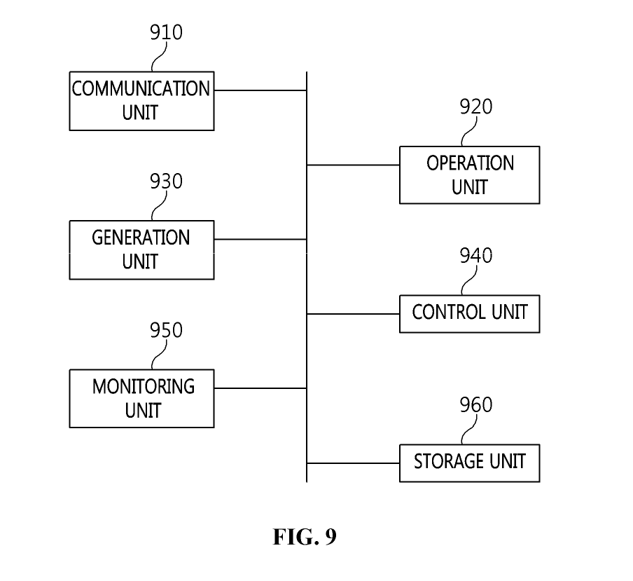

FIG. 9 is a block diagram that shows a server for one-click purchasing according to an embodiment of the present invention.

Referring to FIG. 9, a server for one-click purchasing according to an embodiment of the present invention includes a communication unit 910, an operation unit 920, a generation unit 930, a control unit 940, a monitoring unit 950, and a storage unit 960.

The communication unit 910 functions to send and receive information that is necessary for one-click purchasing to and from the user terminal of a user over a communication network. Particularly, the communication unit 910 according to an embodiment of the present invention may deliver a one-click push message to the user terminal, and may receive information corresponding to one-click input in response to the one-click push message from the user terminal.

Here, the communication unit 910 may send information corresponding to the automatically repeating order to a Point-Of-Sales (POS) terminal installed in an offline store, that is, the store corresponding to the automatically repeating order.

The operation unit 920 analyzes the repeated order pattern of a user based on purchase information of the user stored through an application.

Here, the application runs based on the server for one-click purchasing, and may be a program that is used to make payment when a user buys a product or an item. For example, the payment method of the user is registered in the application, whereby purchase information may be created whenever the user buys a product using the corresponding payment method.

Here, the purchase information may be stored so as to match the account of respective users of the application, and may alternatively be stored in a separate database for one-click purchasing.

Here, the database may be included in the server for one-click purchasing, or may be separate therefrom.

Here, the repeated order pattern may be detected based on similar purchases that are repeatedly found in the user's purchase list included in the purchase information. For example, if user A orders an Americano at café B at 8:30 a.m. on weekdays, information, such as “8:30 a.m. on weekdays, café B, Americano”, in which the time and the place at which an order is placed and an ordered item are sequentially listed, may be extracted as the repeated order pattern of user A.

Here, the repeated order pattern may be extracted based on purchases repeatedly found more than a preset number of times in the purchase information of the user.

For example, if the preset number is five, when user A orders chicken from chicken restaurant C on the first Sunday for five successive months, information such as “the first Sunday of every month, chicken restaurant C, chicken” may be extracted as the repeated order pattern of user A.

Here, because a repeated order pattern is analyzed and extracted depending on the preset number, a single user may have multiple repeated order patterns.

In the above examples, the first repeated order pattern, corresponding to “8:30 a.m. on weekdays, café B, Americano”, and the second repeated order pattern, corresponding to “the first Sunday of every month, chicken restaurant C, chicken”, may be analyzed and extracted for user A.

The generation unit 930 generates an automatically repeating order for a user based on a repeated order pattern.

Here, the automatically repeating order may be data for automatically and repeatedly placing an order corresponding to the repeated order pattern.

For example, when the repeated order pattern of user A is “8:30 a.m. on weekdays, café B, Americano”, an automatically repeating order may be generated in order to actually order an Americano from café B at 8:30 a.m. on weekdays.

Here, the automatically repeating order may be generated in the server so as to be placed through the application. For example, the repeated order pattern of user A is analyzed and extracted, and order data corresponding to the automatically repeating order may be connected with user A's information registered in the application. That is, through the user account in the application, order data for the automatically repeating order for each user may be managed.

The control unit 940 sets an event time for an automatically repeating order, and sends information about an event corresponding to the automatically repeating order using a one-click push message at the event time.

Here, the event time may be the time at which the one-click message is to be sent in order to provide the user with the event corresponding to the automatically repeating order.

Here, the one-click push message may be displayed on the display of the user terminal of the user.

Here, the one-click push message may include a question asking the user whether to use the automatically repeating order. That is, the one-click push message may provide a user interface through which the user may decide whether to use the automatically repeating order with a sing click or a single touch.

For example, the one-click push message may include an order button for ordering a menu item or a product using the automatically repeating order and a cancel button for canceling the automatically repeating order.

Here, when the current time is the event time, whether to send information about the event may be determined depending on whether the user is moving along a routine route extracted from the repeated order pattern.

For example, assume that an automatically repeating order for ordering a ham and cheese sandwich from sandwich shop B at 8 a.m. on weekdays is generated for user A, and that a routine route is a route along which user A goes to work from home. Here, if user A moves to another place at 8 a.m. on a weekday for a business trip, the provision of the event corresponding to the automatically repeating order may become a useless operation that needlessly loads the server.

Accordingly, in order to prevent this problem, whether the route along which a user is moving matches a routine route extracted from the repeated order pattern is checked first, and then the one-click push message may be sent to the user terminal of the user.

For example, the route along which the user is moving may be tracked or acquired using a GPS included in the user terminal. Here, without limitation to the method using the GPS, various methods and methods that have yet to be developed may be used to track or acquire the route along which the user is moving.

Here, the event time may be set based on at least one of the repeated order time of the user, extracted from the repeated order pattern, and the time taken for the store taking the automatically repeating order to prepare the ordered item.

For example, if the repeated order pattern of user B is “9 a.m. on weekdays, the café in front of the house, Café Latte”, the event time at which a one-click push message is to be sent may be set to be earlier than 9 a.m. That is, because it is expected that user B arrives at the café in front of the house at 9 a.m. based on the repeated order time, the event time may be set such that preparation of a Café Latte is completed when user B arrives. If it takes about 5 minutes to make a Café Latte, the event time is set to 8:55 a.m., so that the one-click push message may be sent at 8:55 a.m. on weekdays.

Therefore, according to an embodiment of the present invention, the event time may be set differently depending on the type of product that is repeatedly ordered using the automatically repeating order.

Here, the expected arrival time of a user is calculated based on the current position of the user, and the event time may be changed in consideration of the expected arrival time. That is, although a user repeatedly buys a certain product in the offline store, the user may not always visit the offline store at the same time. Therefore, for the store expected to be visited by the user using the repeated order pattern, the expected arrival time of the user is calculated, and the event time may be adjusted depending on the expected arrival time.

In the above example, when user B arrives at the café at 9:30 a.m., which is 30 minutes later than usual, a Café Latte made in response to the one-click message sent at 8:55 a.m. would get cold because user B arrives 30 minutes after the Café Latte is made. That is, because it is difficult for user B to always arrive at the café at precisely 9 a.m., the event time may be changed such that the Café Latte is made by the time at which the user is expected to arrive at the café.

The monitoring unit 950 checks whether an event having a comparative advantage over the automatically repeating order is generated.

Here, the control unit 940 may provide information for a more advantageous purchase along with the one-click push message when the event having a comparative advantage is generated.

Here, the event having a comparative advantage may be an event that is generated in order to provide information for a more advantageous purchase when there is information that is more advantageous or efficient to a user than a purchase using the automatically repeating order.

Also, the control unit 940 may determine whether information for a more advantageous purchase is present by comparing a store corresponding to the automatically repeating order with multiple stores registered in the application based on order information corresponding to the automatically repeating order, and may generate an event having a comparative advantage when it is determined that the information for a more advantageous purchase is present.

Here, based on at least one of the price of menu items, the location of a store, coupon information, and a grade, the store corresponding to the automatically repeating order may be compared with the multiple stores.

For example, assume that there is a user who repeatedly buys chicken at store A in the evening of the first Sunday of every month using a one-click push message. Here, if store B located near store A sells chicken at a lower price than store A, among the multiple stores registered in the application, it is determined that there is information for a more advantageous purchase, which corresponds to store B, and an event having a comparative advantage may be generated.

Alternatively, in the above example, if store A and store B sell chicken at the same price but store B offers a coupon through which chicken is provided free when chicken is bought ten times at store B, it may be determined that there is information for a more advantageous purchase.

Alternatively, in the above example, when store A and store B sell chicken at the same price and offer a coupon under the same conditions, but store B is more accessible than store A based on the position of the user, it may be determined that there is information for a more advantageous purchase.

Alternatively, in the above example, when store A and store B sell chicken at the same price, offer a coupon under the same conditions, and have the same accessibility, but the grade of store B given by users is higher than the grade of store A, it may be determined that there is information for a more advantageous purchase.

Also, the control unit 940 may place an automatically repeating order with the store corresponding to the automatically repeating order when a user requests the automatically repeating order based on the event.

Here, the server according to an embodiment of the present invention sends order information corresponding to the automatically repeating order to the store, whereby the store may prepare a menu item or product corresponding to the automatically repeating order.

Here, the payment for the automatically repeating order may be made using the payment method of the user registered in the application. For example, a user may register his or her credit card information in the application, or may load money onto online cash, corresponding to the payment method in the application, and use the online cash for the automatically repeating order.

Here, the store taking the order may deliver the ordered menu item or product to the user after checking the user based on the user information corresponding to the automatically repeating order.

The storage unit 960 stores various kinds of information generated in the above-described process for one-click purchasing according to an embodiment of the present invention.

According to an embodiment, the storage unit 960 may support the function for one-click purchasing in a manner that is separate from the server. Here, the storage unit 960 may function as separate mass storage, and may include a control function for performing operations.

Meanwhile, the server may store information in memory installed therein. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard disk device, an optical disk device, or any other mass storage.

Through the above-mentioned server, there may be provided a method for enabling a user to easily order a menu item that is frequently used by the user before arriving at a store.

Also, a product that is suitable for a user is automatically found and information thereabout is provided, whereby the user may select and order a better product, and a seller may increase sales.

Also, an event for placing an order appropriate for a user's situation is generated, whereby the user may automatically place an order depending on the circumstances without manually making complicated settings.

The functional operations and implementations of the subject matter described herein may be implemented as digital electronic circuitry, or may be implemented in computer software, firmware, or hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium in order to control the operation of a processing system or to be executed by the processing system.

The computer-readable medium may be a machine-readable storage device, a machine-readable storage substrate, a memory device, a composition of material that affects a machine-readable radio wave type signal, or one or more combinations thereof.

As used herein, the terms “system” or “device” include all kinds of apparatuses, devices and machines for processing data, which include, for example, a programmable processor and a computer, or multiple processors and a computer. In addition to hardware, the processing system may also include, for example, code that configures processor firmware, and code that configures an execution environment for computer programs in response to a request from a protocol stack, a database management system, an operating system, or one or more combinations thereof.

A computer program (also known as a program, software, a software application, a script or code) may be written in any form of a programming language including a compiled or interpreted language, or an a priori or procedural language, and may be deployed in any form including stand-alone programs or modules, components, subroutines, or other units suitable for use in a computer environment. The computer program does not necessarily correspond to a file in a file system. The program may be stored in a single file provided to the requested program, in multiple interactive files (for example, files storing one or more modules, subprograms or portions of code), or in a part of a file containing other programs or data (for example, one or more scripts stored in a markup language document). The computer program may be located on a single site or distributed across multiple sites such that it is deployed to run on multiple computers interconnected by a communications network or on a single computer.

The computer-readable medium suitable for storing computer program instructions and data may include, for example, semiconductor memory devices, such as EPROM, EEPROM and flash memory devices, all types of nonvolatile memory, including magnetic disks, such as internal hard disks or external disks, magnetic optical disks, CD-ROMs and DVD-ROMs, media, and memory devices. A processor and memory may be supplemented by special-purpose logic circuits or integrated therewith.

Implementations of the subject matter described herein may be realized on an arithmetic system including, for example, a back-end component such as a data server, a middleware component such as an application server, a front-end component such as a client computer with a web browser or a graphical user interface through which a user may interact with the implementations of the subject matter described herein, or one or more combinations of the back-end component, the middleware component, and the front-end component. The components of the system may be interconnected using any form or medium of digital data communication such as a communication network.

While the present invention includes a number of specific implementation details, they should not be construed as limitations on the scope of the invention or the claimable scope, but should be understood as a description of features that may be specific to particular embodiments of the invention. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may be excluded from the combination in some cases, and the claimed combination may be altered to a sub-combination or variation thereof.

Also, while this specification illustrates operations in the drawings in a particular order, it should not be understood that such operations must be performed in the particular order or the sequential order shown in the drawings in order to obtain a desired result, or that all of the illustrated operations should be performed. In certain cases, multitasking and parallel processing may be advantageous. Also, the separation of the various system components of the above-described embodiment should not be understood as requiring such separation in all embodiments, and it should be understood that the program components and systems described above may generally be integrated into a single software product or packaged into multiple software products.

According to the present invention, there may be provided a method for enabling a user to easily order a menu item that is frequently used by the user before the user arrives at a store.

Also, according to the present invention, a product suitable for a user may be automatically found and information thereabout may be provided, whereby the user may select and order a better product, and a seller may increase sales.

Also, according to the present invention, an event for enabling a user to place an order appropriate for his or her situation may be generated, whereby the user may automatically place an order depending on the circumstances without manually making complicated settings.

According to the present invention, the repeated order pattern of a user is analyzed based on purchase information stored through an application, an automatically repeating order is generated for the user based on the repeated order pattern, an event time for the automatically repeating order is set, and an event corresponding to the automatically repeating order is provided to the user by sending a one-click push message at the event time, whereby an automatic order event that is more convenient and suitable for the user may be provided, and a store may reliably maintain the number of orders that it takes. Also, the present invention may improve the user's satisfaction with various offline stores that offer products based on an event having a comparative advantage, and may be widely used in fields such as product recommendation, service offering, automatic payment, and the like depending on the purchasing pattern of a user.

This specification is not intended to limit the present invention to the specific terms disclosed herein. Therefore, although the present invention has been described in detail with reference to the above examples, those skilled in the art may conceive alternations, modifications, and variations on these examples without departing from the scope of the present invention. The scope of the present invention is defined by the appended claims rather than the description, and it should be construed that all alternations and modifications derived from the meaning and scope of the appended claims and their equivalents are included within the scope of the present invention.

What is claimed is:

1. A method for one-click purchasing, comprising:
analyzing a repeated order pattern of a user based on purchase information of the user, which is stored through an application;
generating an automatically repeating order for the user based on the repeated order pattern; and
setting an event time for the automatically repeating order and sending information about an event corresponding to the automatically repeating order to the user at the event time using a one-click push message.

2. The method of claim 1, further comprising:
checking whether an event having a comparative advantage over the automatically repeating order is generated; and
providing information for a more advantageous purchase along with the one-click push message when the event having the comparative advantage is generated.

3. The method of claim 1, wherein sending the information about the event is configured to decide whether to send the information about the event depending on whether the user moves along a routine route extracted from the repeated order pattern when a current time is the event time.

4. The method of claim 1, wherein sending the information about the event comprises:
setting the event time based on at least one of a repeated order time of the user, extracted from the repeated order pattern, and a time taken for a store taking the automatically repeating order to prepare an ordered product.

5. The method of claim 4, wherein setting the event time comprises:
calculating an expected arrival time of the user based on a current position of the user and changing the event time in consideration of the expected arrival time.

6. The method of claim 2, further comprising:
determining whether there is information for the more advantageous purchase by comparing a store corresponding to the automatically repeating order with multiple stores registered in the application based on order information corresponding to the automatically repeating order, and then generating the event having a comparative advantage when it is determined that there is the information for the more advantageous purchase.

7. The method of claim 6, wherein generating the event having a comparative advantage is configured to compare the store with the multiple stores based on at least one of a price of a menu item, a location of the store, coupon information, and a grade.

8. The method of claim 1, further comprising:
placing the automatically repeating order with a store corresponding to the automatically repeating order when the user requests the automatically repeating order based on the event.

9. A server, comprising:
an operation unit for analyzing a repeated order pattern of a user based on purchase information of the user, which is stored through an application;
a generation unit for generating an automatically repeating order for the user based on the repeated order pattern; and
a control unit for setting an event time for the automatically repeating order and sending information about an event corresponding to the automatically repeating order to the user at the event time using a one-click push message.

10. The server of the claim 9, further comprising:
a monitoring unit for checking whether an event having a comparative advantage over the automatically repeating order is generated, and
wherein the control unit provides information for a more advantageous purchase along with the one-click push message when the event having a comparative advantage is generated.
